(19) United States
(12) Patent Application Publication
(10) Pub. No.: US 2005/0198249 A1
(43) Pub. Date: Sep. 8, 2005

(54) Apparatus and method for managing network device by updating remote service object dynamically

(76) Inventors: Tae-In Hwang, Daejeon-city (KR); Ho-Jin Park, Daejeon-city (KR); Dae-Ung Kim, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/964,498

(22) Filed: Oct. 12, 2004

(30) Foreign Application Priority Data
Dec. 26, 2003 (KR) 10-2003-0097549

(51) Int. Cl. G06F 15/173; G06F 15/16

(52) U.S. Cl. 709/223; 709/202

(57) ABSTRACT

Disclosed is a system for dynamically updating remote service objects to manage a network device having various characteristics by Java RMI (Remote Method Invocation), and a method thereof. The system includes a network device manager for authenticating a transmission message communicated between a network device and a management device and transferring and initializing objects for management of the network device, and a management agent. The management method includes a remote object transmission step, a remote object authentication step, a remote object installation step, and a network device management step.

### CROSS REFERENCE TO RELATED APPLICATION

This application claims priority to and the benefit of Korea Patent Application No. 2003-97549 filed on Dec. 26, 2003 in the Korean Intellectual Property Office, the entire content of which is incorporated herein by reference.

### BACKGROUND OF THE INVENTION

(a) Field of the Invention

The present invention relates to a system for dynamically updating remote service objects for control and management of various network devices, a method thereof, and a computer-readable recording medium storing a program for realizing the method. More specifically, the present invention relates to a network device management method that, based on a Java RMI (Remote Method Invocation) API (Application Program Interface), enables a management device to install a management service necessary for integral management of various network devices, and the network device to register its inherent management function in the management device, thereby collecting general management information to be managed by the management device and providing the management device with a management and control service characterized to the devices provided by the network device.

(b) Description of the Related Art

In general, a network device management system comprises a management server and a network device.

The conventional network device management server accumulates data by polling information stored in the network devices belonging to it, and processes the accumulated data for analysis to determine performance and problems of the network. Communication between the network management server and the network device is achieved according to a protocol such as SNMP (Simple Network Management Protocol) or CMIP (Common Management Information Protocol).

FIG. 1 is a block diagram of a conventional network device management system.

Generally, the network device management system comprises a network management device 10 and a management agent 20.

The network management device 10 provides an interface for a network manager to monitor the situation of the network, and has a database for some functions regarding management data analysis, problem management, etc.

The management agent 20, which is provided in an object to be managed, for example, network equipment such as host, router, bridge, or hub, transmits management information at the request of the management system or requests the management system for an action, and automatically reports a problem situation to the management system upon occurrence of a problem.

Here, MIB (Management Information Base) 21 is a database including information about the factors to be managed in a management model based on TCP/IP. The information under management is called management objects 30, 31, and 32. The MIB 21 comprises a hierarchical tree of the management objects.

SNMP (Simple Network Management Protocol) is a protocol for monitoring and control of operations between the network management device 10 and a network device. According to SNMP, the management agent 20 collects information about the management objects under management by a “get” message, and sets information of the network device by a “set” message.

By a “trap” message, the management agent 20 directly reports a problem situation to the network management device 10, rather than by the polling of the network management device 10.

On the other hand, the MIB 21 managed by the management agent 20 is a formal description for objects managed according to SNMP, and the format of the MIB 21 is defined as a part of SNMP. Among the MIBs, MIB-I is the definition of the initial MIB, and MIB-II is the definition of the current MIB. The equipment each define its necessary operation management MIB and manages necessary management information.

Generally, some knowledge of the network management technology is required so as to implement a management system based on a network management protocol, and the system of defining information to be managed and describing the definitions of the information is considerably complicated. In addition, it is impossible to dynamically upgrade a module for providing a new management service, because management systems mostly use the SNMPv1 or SNMPv2 system. The SNMPv3 suggests an extendible structure for solving this problem, but it is too complex to implement.

As described above, the conventional management system based on the network management protocol has a difficulty in adding a new management function and hardly enables a developer who is not an expert on the network management protocol to develop an agent for providing network device management information and a management server for processing and managing the network device management information.

### SUMMARY OF THE INVENTION

It is an advantage of the present invention to provide a network management system that transfers remote objects to manage a network device having different characteristics at a remote location between a management device and a network device through an authentication process and provides a new management service using the remote objects, a method thereof, and a computer-readable recording medium storing a program for implementation of the method.

In one aspect of the present invention, there is provided a network device management method including: (a) a network device requesting a management device to transmit a management device implementation object, and receiving the requested management device implementation object; (b) the network device authenticating and decoding the received management device implementation object; (c) a management agent of the network device storing and registering the management device implementation object; and (d) the management device calling an implementation object of the network device through an interface object, and outputting a corresponding result value.

In another aspect of the present invention, there is provided a network device management method including: (a) a management device requesting a network device to transmit a network device interface object, and receiving the network device interface object; (b) the management device authenticating and decoding the received network device interface object; (c) a network device manager of the management device storing and registering the network device interface object; and (d) the network device manager calling an implementation object of the network device through the interface object, and outputting a corresponding result value.

In another aspect of the present invention, there is provided a network device dynamically updating a service object for network management of a management device, the network device including: a management agent for requesting a network device manager of the management device to transmit a management device implementation object, receiving an encoded implementation object, and authenticating and decoding the received implementation object.

In still another aspect of the present invention, there is provided a management device dynamically updating a service object to control and manage a network device, the management device including: a network device manager for requesting a remote management agent to transmit a network device interface object, receiving the encoded object, authenticating and decoding the received object, and installing the authenticated and decoded object in the management device.

As described above, for the enabled management device to integrally manage the management function of various network devices and to update a new management function, the present invention divides an object implementing the management function into an interface object and an implementation object, installs the interface object and the implementation object in the management device and the network device, respectively, and performs RMI communication between the management device and the network device, thereby managing the network device in a safe and easy way.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is a block diagram of a conventional network device management system;

FIG. 2 is a block diagram of a network device management system according to an embodiment of the present invention;

FIG. 3 is a schematic flow chart showing a process for dynamically updating a management service according to an embodiment of the present invention;

FIG. 4 is a schematic flow chart showing a method for dynamically updating a management device implementation object in a network device according to an embodiment of the present invention; and

FIG. 5 is a flow chart showing a method for dynamically updating a network device interface object in a management device according to an embodiment of the present invention.

### DETAILED DESCRIPTION OF THE PREFERRED EMBODIMENTS

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive. To clarify the present invention, parts which are not described in the specification are omitted, and parts for which similar descriptions are provided have the same reference numerals. A connection between one part to another includes a direct connection between them, or an electrical connection via a third device.

Hereafter, a network device management method according to an embodiment of the present invention will be described in detail with reference to the accompanying drawings.

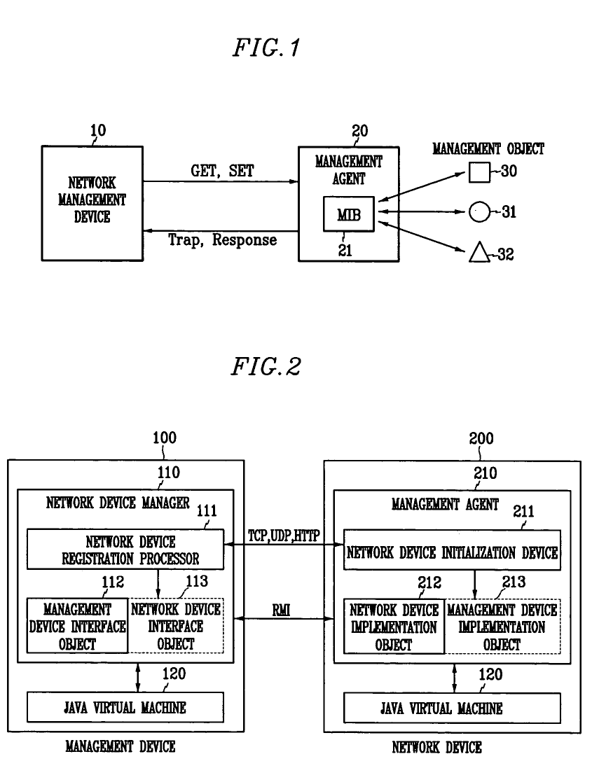

FIG. 2 is a block diagram of a network device management system according to an embodiment of the present invention.

Referring to FIG. 2, the network device management system according to the present invention comprises a management device 100 having a network device manager 110, a management agent 210, and a network device 200.

The network device manager 110 comprises a network device registration processor 111, a network device interface object 113, and a management device interface object 112. The management agent 210 comprises a network device initialization processor 211, a network device implementation object 212, and a management device implementation object 213.

The management device 100 and the network management device 200, each equipped with a virtual machine 120, are operated on the Java virtual machines 120.

Hereinafter, the operation of the embodiment of the present invention will be described in detail.

The network device registration processor 111 requests the network device initialization processor 211 to transmit a network device interface object, receives the network device interface object, and authenticates and decodes the received interface object with a given public key and a received message authentication code.

Subsequent to the message authentication, the network device registration processor 111 stores the network device interface object 113 and reports the addition of a new management service to the network device manager 110. The network device manager 110 uses the received interface object 113 to generate a user interface for management of the updated network device 200.

The network device interface object 113 is an interface for providing device information that is an object to be installed at the release time of the device by the manufacturer, and is based on inherent functions and hardware characteristics of the device.

The management device interface object 112 is an interface for providing a management service that can be managed with an application program interface (API) supported by Java, rather than using hardware commonly managed by the network devices 200 in the management device 100.

The network device initialization processor 211 of the management agent 210 requests the network device registration processor 110 to transmit a management device implementation object, receives the requested implementation object, and authenticates and decodes the received implementation object with a given public key and a received message authentication code.

Subsequent to the authentication, the management device implementation object 213 is stored and registered on a remote method invocation (RMI) registry. The management device implementation object 213 is a service implementation object for providing device information which is an object to be installed at the release time of the device by the manufacturer, and is based on inherent functions and hardware characteristics of the device.

The management device implementation object 213 is an implementation object for providing a management service that can be managed with an API supported by Java, rather than using hardware commonly managed by the network devices 200 in the management device 100.

Hereinafter, the method for dynamically updating a network device management service using the construction of the system according to an embodiment of the present invention will be described.

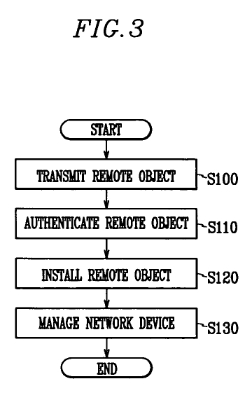

FIG. 3 is a schematic flow chart showing a process for dynamically updating a management service according to an embodiment of the present invention.

The network device 200 and the management device 100 request a remote object and receive the interface object 113 and the implementation object 213, respectively, in step S100.

The network device 200 or the management device 100 authenticates the effectiveness of the received remote object, and if the object is effective, decodes the remote object, in step S110.

After the completion of the authentication and decoding step, the network device manager 110 or the management agent 210 stores and installs the remote object, in step S120.

The network device manager 110 uses the received interface object and a given interface object to call the implementation object 212 of the network device and the received implementation object, outputs a corresponding result value, and manages the network device, in step S130.

Hereinafter, the method for dynamically updating remote service objects for the network device and the management device, respectively, will be described in detail.

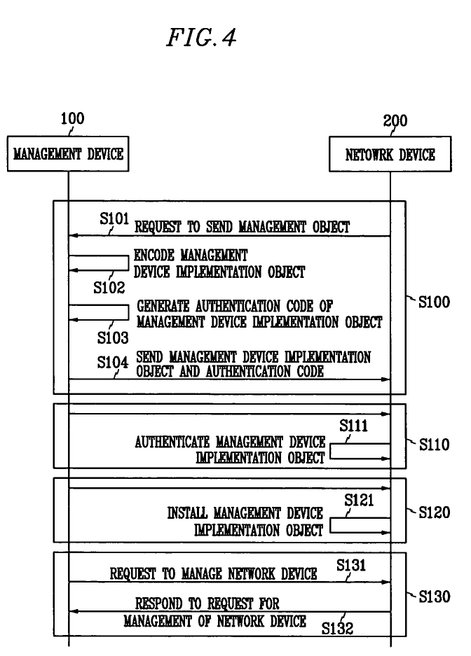

FIG. 4 is a schematic flow chart showing a method for dynamically updating a management device implementation object in the network device according to an embodiment of the present invention.

The network device 200 requests the management device 100 to transmit a remote object, in step S101.

Upon receiving the request message for the remote object, the management device 100 encodes the management device implementation object, in step S102, and uses a given public key to generate an authentication code for a message to be transmitted, in step S103.

The generated message authentication code and the encoded management device implementation object are transmitted to the network device 200, in step S104.

The network device 200 authenticates the effectiveness of the received message, and if the message is effective, decodes the management device implementation object, in step S121. Then, the network device 200 registers the management device implementation object on the RMI registry of the network device 200, in step S121.

The network device manager 110 uses the management device interface object in the management device 100 to call the management device implementation object registered on the network device 200, and requests management of the network device, in step S131.

In response to this, the network device 200 returns the result value for the call of the management device implementation object, in step S132.

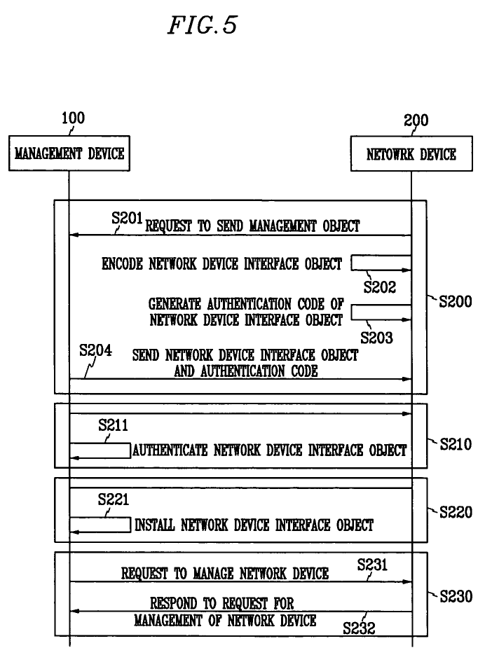

FIG. 5 is a flow chart showing a method for dynamically updating a network device interface object in the management device according to an embodiment of the present invention.

The management device 100 requests the network device 200 to transmit a management object, in step S201.

Upon receiving the request message for the management object, the network device 200 encodes a network device interface object, in step S202, and uses a given public key to generate an authentication code for a message to be transmitted, in step S203.

The generated message authentication code and the encoded network device interface object are transmitted to the management device 100, in step S204.

The management device 100 authenticates the effectiveness of the received message, and if the message is effective, decodes the network device interface object, in step S210. Then, the management device 100 reports the decoded interface object to the network device manager 110, in step S221.

The network device manager 110 uses the network device interface object in the management device 100 to call the network device implementation object registered on the network device 200, and requests management of the network device, in step S231.

In response to this, the network device 200 returns the result value for the call of the network device implementation object, in step S232.

The above-described method of the present invention can be implemented into a program and stored in a computer-readable recording medium (e.g., CD-ROM, RAM, ROM, floppy disk, hard disk, magneto-optical disc, etc.).

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

The above-stated construction of the present invention enables a system manager or a service provider to transmit an object of a new management function to the network device for installation at a remote location, SO the present invention easily applies new management functions to the network device to facilitate the management of newly developed network devices in an integral manner, and guarantees its implementation without a complicated network management protocol, thereby enabling any developer not skilled in network device management to easily develop the management system.

1. A network device management method, which is for a network device management system, the network device management method comprising:
(a) a network device requesting a management device to transmit a management device implementation object, and receiving the requested management device implementation object;
(b) the network device authenticating and decoding the received management device implementation object;
(c) a management agent of the network device storing and registering the management device implementation object; and
(d) the management device calling an implementation object of the network device through an interface object, and outputting a corresponding result value.

2. A network device management method, which is for a network device management system, the network device management method comprising:
(a) a management device requesting a network device to transmit a network device interface object, and receiving the network device interface object;
(b) the management device authenticating and decoding the received network device interface object;
(c) a network device manager of the management device storing and registering the network device interface object; and
(d) the network device manager calling an implementation object of the network device through the interface object, and outputting a corresponding result value.

3. The network device management method as claimed in claim 1, comprising:
storing the received management device implementation object in a remote method invocation (RMI) registry by the management agent.

4. The network device management method as claimed in claim 1, further comprising:
returning the result value of the implementation object called by the network manager to the network manager.

5. The network device management method as claimed in claim 2, further comprising:
returning the result value of the implementation object called by the network manager to the network manager.

6. A network device, which dynamically updates a service object for network management of a management device, the network device comprising:
a management agent for requesting a network device manager of the management device to transmit a management device implementation object, receiving an encoded implementation object, and authenticating and decoding the received implementation object.

7. The network device as claimed in claim 6, wherein the management agent comprises:
a network device initialization processor for requesting the management device to transmit the management device implementation object, receiving the implementation object, authenticating and decoding the received implementation object with a given public key and a received message authentication code, and registering the implementation object on a RMI registry;
a network device implementation object for providing device information based on inherent functions and hardware characteristics of the network device; and
a management device implementation object for providing a management service capable of being managed using an application program interface (API) provided in Java.

8. A management device, which is for dynamically updating a service object to control and manage a network device, the management device comprising:
a network device manager for requesting a remote management agent to transmit a network device interface object, receiving the encoded object, authenticating and decoding the received object, and installing the authenticated and decoded object in the management device.

9. The management device as claimed in claim 8, wherein the network device manager comprises:
a network device registration processor for requesting the network device to transmit a network device interface object, receiving the requested interface object, authenticating and decoding the received interface object with a given public key and a received message authentication code, and reporting the addition of a new management service;
a network device interface object for providing device information based on inherent functions and hardware characteristics of the management device; and
a management device interface object for providing a management service capable of being managed using an API supported by Java.
